(19) United States
(12) Patent Application Publication
(10) Pub. No.: US 2007/0106631 A1
(43) Pub. Date: May 10, 2007

(54) Database server discovery using a configuration file

(76) Inventor: Bruce Wobbe, San Jose, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/270,910

(22) Filed: Nov. 10, 2005

(51) Int. Cl. G06F 17/30

(52) U.S. Cl. 707/1

(57) ABSTRACT

In various embodiments, the present invention provides methods and systems for enabling client machines to discover server configuration information for accessing a remotely stored file. A first client identifies a remotely stored file and determines if an associated configuration file exists. If a configuration file exists, the client uses the configuration information to discover the server to access the file. If a configuration file does not exist, the client determines whether a server local to the file is available. If so, the client uses that server to access the file. If not, the client uses a server local to the client machine to access the file. The first client then creates a configuration file so that subsequent clients attempting to access the file can use the configuration file to discover the server to use to access the file.

### BACKGROUND

This invention relates to systems and methods for discovering a database server to access a remotely stored file. It is desirable for an application running on a client machine to be able to access an associated data file regardless of where it resides on a network. Moreover, it is desirable to manage access to a file by multiple client machines through a single server. However, it is not always apparent which server is used to access the file at the file's current location and how to establish a connection with that server. Client machines must therefore discover which server to use and how to establish a connection with that server in order to access the desired file.

One option is for the server to broadcast the information needed to connect with it using TCP/IP or UDP. However, certain firewalls block a client machine's ability to receive such transmissions from a server. In addition, for security purposes, it may be unwise to have a server announce its location because it might then become the target for malicious attacks. Thus, it is difficult to dependably and securely communicate server configuration information to a variety of client machines using server broadcasts.

Another option is to use Open Database Connectivity (ODBC), a standard application programming interface (API) for accessing data in a database. ODBC can be used to store information needed to access a data file in a registry on every machine that needs to access the data file. Because the configuration information is stored separately on all client machines, any changes in the location of the data file or the configuration information would cause the information on all the machines to become outdated. Thus, using ODBC, it is difficult to manage the dynamic aspects of the configuration because the information is distributed to all client machines and information updates need to be likewise distributed.

### SUMMARY

In various embodiments, the present invention provides methods and systems for enabling client machines to discover server configuration information for accessing a remotely stored file or other resource. Client machines can optionally use a server present on the same machine as the file or use a server on a client machine or other location to access the file. A first client identifies a remotely stored file and determines if an associated configuration file exists. If a configuration file exists, the client uses the configuration information in the file to determine the identity and location of the server and the information needed to use the server to access the file. If a configuration file does not exist, the client determines whether a server local to the file is available. If a server local to the file is available, the client uses that server to access the file. If a server local to the file is not available, the client uses a server on the client machine to access the file. In either of these cases where a configuration file does not exist, the first client creates a configuration file comprising information identifying the server used and the configuration information needed to use the server. Thus, subsequent clients attempting to access the file can use the configuration file to discover the identity and location of the server and the information needed to use the server to access the file.

In one variation, the configuration file only exists for the duration of the period that the file is being accessed by the first client. In another variation, the configuration file, once created, persists after the file is closed.

### BRIEF DESCRIPTION OF THE DRAWINGS

FIG. 1 is an illustration of one embodiment of a system for accessing a file stored on a remote machine using a server on the same machine as the file.

FIG. 2 is an illustration of one embodiment of a system for accessing a file stored on a remote machine using a server on a client machine.

FIG. 3 is a flow chart of one embodiment of a method of discovering a server for accessing a file stored on a remote machine.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

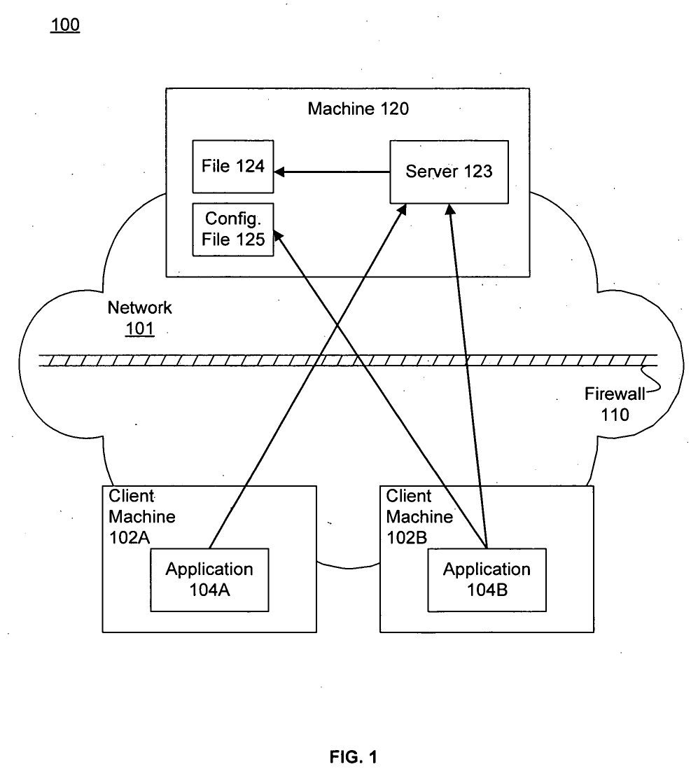

FIG. 1 illustrates one embodiment of a system 100 whereby client machines 102A and 102B can access a file 124 stored on a remote machine 120 using a server 123 on the same machine 120 as the file 124.

The system 100 comprises client machines 102A and 102B and machine 120, where client machines 102A and 102B and machine 120 are all communicatively coupled to a network 101. Network 101 can be any network, such as the Internet, a LAN, a MAN, a WAN, a wired or wireless network, a private network, or a virtual private network. Network 101 thus enables a transfer of information between the client machines 102A and 102B and machine 120. In one embodiment, client machines 102A and 102B are separated from machine 120 by a firewall 110. In one implementation, firewall 110 prevents the client machines 102A and 102B behind the firewall from receiving broadcasts from servers on the network 101. In another embodiment, firewall 110 is not present.

In the embodiment shown in FIG. 1, machine 120 comprises a server 123, a file 124, and a configuration file 125. In this example, the server 123 manages access to file 124. File 124 can be, for example, a data file used by applications 104A and 104B, described below. Configuration file 125 is associated with data file 124. Configuration file 125 comprises information specifying the server used to access the associated data file 124 and the information needed to use the server to access the associated data file 124. In this example, the configuration file 125 specifies server 123 for accessing data file 124. As shown in FIG. 1, the configuration file 125 is centrally stored so as to avoid the problem of having to update multiple instances of the configuration information as configuration information changes.

The client machines 102A and 102B can be computers, cell phones, personal digital assistants (PDA) or any other electronic devices. Client machines 102A and 102B run client software applications 104A and 104B. In one embodiment, client software applications 104A and 104B use data file 124. For example, client software applications 104A and 104B can be copies of a financial management software application that processes data stored in file 124. In the embodiment shown in FIG. 1, the client software application 104A running on client machine 102A can access the file 124 using the server 123 on the same machine 120 as the file 124. The client software application 104B running on client machine 102B can access configuration file 125 and can also access the file 124 using the server 123.

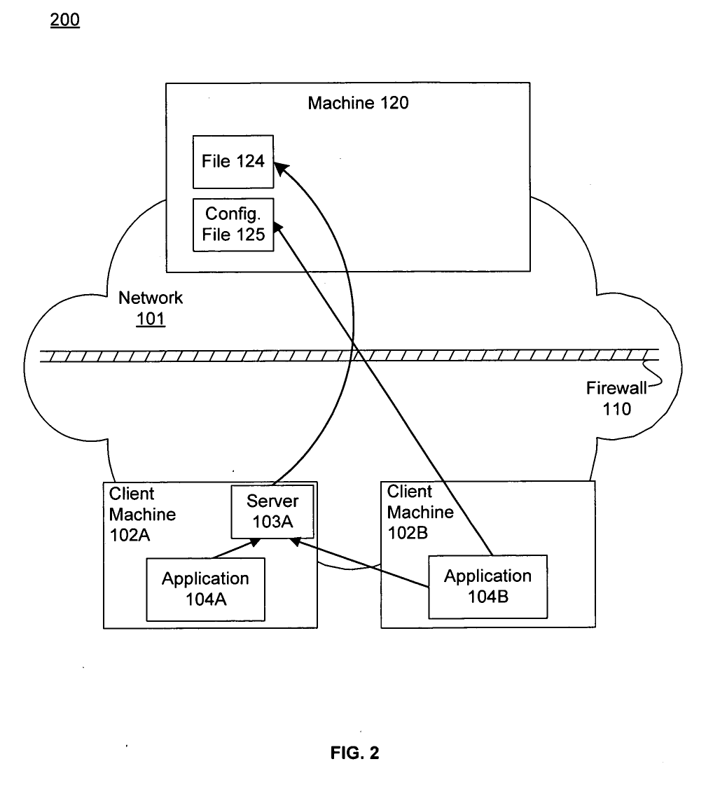

FIG. 2 illustrates one embodiment of a system 200 whereby client machines 102A and 102B can access a file 124 using a server 103A on client machine 102A.

In the example of FIG. 2, the system 200 comprises client machines 102A and 102B and a remote machine 120 that stores a file 124 and a configuration file 125. In this example, the machine 120 where the file 124 is located does not have an available local server. However, client machine 102A does have server 103A. In one embodiment, a server 103A is installed on every client machine as a part of the client software application 104A. Therefore, every client software application is assured of having a local server to access a remote file 124. In one embodiment, where there is a choice between using a server local to the file and a server local to the client machine, the server local to the file is preferred for performance reasons. In this example, because no server local to the file is available, the client machine 102A running client software application 104A uses the server 103A local to the client machine 102A to access file 124. The configuration file 125 in this example specifies server 103A for accessing data file 124. A second client machine 102B running client software application 104B can access the configuration file 125 and can also use the server 103A present on client machine 102A to access file 124.

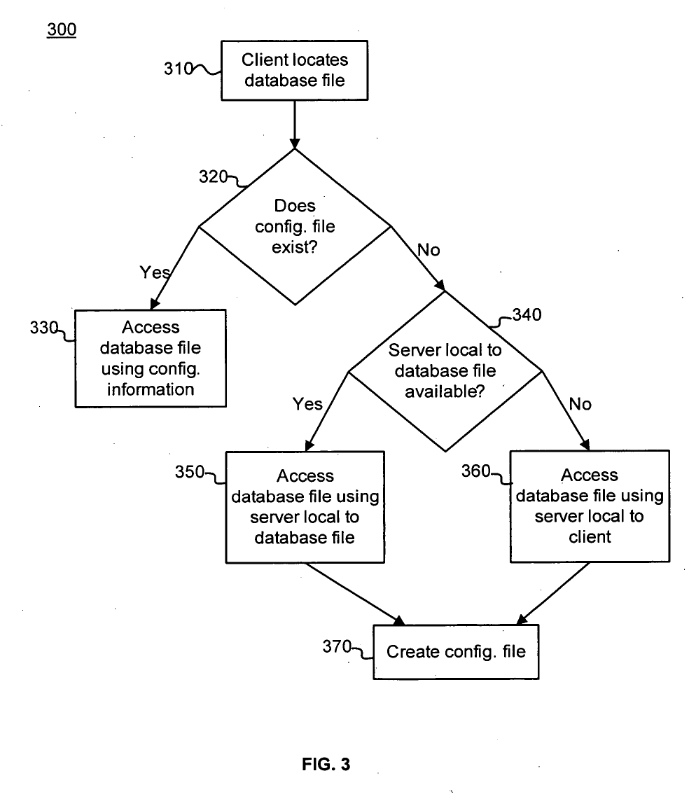

FIG. 3 illustrates one embodiment of a method 300 of discovering a server for accessing a database file stored on a remote machine. This example method will be described in the context of a plurality of client machines running a financial management software application that processes data in a company database file that is stored on a remote machine connected to the client machines via a network. It will be readily understood by those ordinarily skilled in the art that the method could also be applied in other software application and remote resource contexts without departing from the teachings of the invention disclosed herein.

In step 310, a client locates the database file. In one embodiment, a user browses to find the desired database file using a file manager such as Microsoft Windows Explorer. Alternatively, the user can use any other browser to locate and identify the database file. In one embodiment, the client identifies the IP address of the machine where the database file is stored.

In step 320, it is determined whether a configuration file-exists for accessing the database file. The configuration file is used to aid in discovering the server that is hosting the database file. In one embodiment, the configuration file comprises the IP address for the server that is hosting the database file, the name of the server that is hosting the database file, the port of the server that is hosting the database file, and the local path of the file to the server that is hosting the database file. Hence, if a configuration file already exists, there is no need to discover the server via TCP/IP or UDP.

In one embodiment, the configuration file is stored in the same location, such as the same directory file, as the database file. Thus, any client machine that can locate the database file can similarly locate the associated configuration file in a predictable location. Furthermore, the configuration file is centrally stored so that it can be easily deleted, updated and/or replaced.

In one embodiment, the configuration file is named according to a convention. For example, the configuration file can be a network data file with a unique file extension, e.g., “.nd”, at the end of the same file name as the database file. Alternatively, any other naming convention can be used provided that the configuration file can be recognized as the file containing the configuration data needed by a client to connect to a specified server to access the database file across the network.

In one embodiment, the configuration file is created when the database file is opened by a client, and it is deleted when the database file is closed. Alternatively, the configuration file, once created, can be maintained after the database file is closed. In this implementation, a client that uses the configuration file to attempt to access the database file performs a further check that the database file is still accessible according to configuration information stored in the configuration file and alternatively or additionally performs a check that the configuration information is up to date. In one embodiment, if the configuration file is outdated, it is deleted and the method proceeds as if the configuration file did not exist. In another embodiment, if any one of these checks fails, the configuration file is updated. The existence of the configuration file allows for an initial attempt to access the file without independent discovery of the server. If the configuration file is stale, then the client can attempt fallback procedures to discover which information in the configuration file is stale so that it can be updated for subsequent clients.

If a configuration file does exist, the database file is accessed using the configuration information in the configuration file 330. The configuration information in the configuration file specifies the server to use to access the database file and the information needed to connect to the server. Thus, the client has discovered the appropriate server by using the configuration file.

If a configuration file does not exist, it is determined if a server local to the database file is available 340. In one embodiment, the client attempts to contact a server on the machine where the file resides, for example, by sending a ping to the IP address of the file. If the ping is successful (i.e., a server at the IP address responds), then it is determined that an available server local to the database file is present. If the ping is unsuccessful (i.e., a server does not respond), then it is determined that no server local to the database file is available.

If a server local to the database file is available, the client accesses the database file using this server. In one embodiment, to access the server, the client needs the unique name of the server, the port, and the IP address of the server. In one embodiment, the name of the server and the port are established by convention and predefined at the application level, and are only changed in event of a conflict. For example, a change of port would be necessary if there is another application using the same port as was established for the server, and then the port could be changed, for example, at runtime via a Windows INI file. In the situation where a server local to the database file is available, the client knows the IP address of the server because it is the same as the IP address of the file identified in step 310.

If no server local to the database file is available, the client accesses the database file using a server local to the client machine 360. In one embodiment, the client application includes server software capable of managing access to the database file. Thus, the client is assured of having local server capability in the event that it is needed to access a remote database file.

In one embodiment, regardless of whether the database file is accessed by using a server local to the database file 350 or by using the server local to the client machine 360, in step 370, the client creates a configuration file. In another embodiment, another application can create the configuration file, for example, an application that resides on the same machine as the server. In this embodiment, such an application would have more information about the server readily available than the client would have, and such an application could produce the configuration file more easily than the discovery method used by the client. The configuration file includes information needed by clients to connect to the database file using the server that was used by the client that creates the configuration file. In one embodiment, the configuration file is stored in the same location as the database file. Thus, subsequent clients will use the configuration information in the configuration file to discover the appropriate server to access the database file.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “identifying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of discovering a database server to access a first file stored on a remote machine from a client machine, the method comprising:
identifying a location of the first file stored on a remote machine;
responsive to determining that a configuration file associated with the first file does not exist, determining if a server local to the first file is available;
responsive to determining that the server local to the first file is available, accessing the first file using the server local to the first file; and
creating the configuration file associated with the first file, wherein the configuration file identifies the server local to the first file.

2. The method of claim 1, wherein the remote machine is separated from the client machine by a firewall.

3. The method of claim 1, wherein identifying a location of a first file comprises navigating a directory from a client machine to find the first file stored on a remote machine.

4. The method of claim 1, wherein identifying a location of the first file comprises identifying the IP address of the first file.

5. The method of claim 1, wherein determining if a server is available on the remote machine comprises sending a ping to the remote machine.

6. The method of claim 1, wherein the configuration file specifies a name, IP address, and port of the server.

7. A computer-implemented method of discovering a database server to access a first file stored on a remote machine from a client machine, the method comprising:
identifying a location of a first file stored on a remote machine;
responsive to determining that a configuration file associated with the first file does not exist, determining if a server local to the first file is available;
responsive to determining that no server local to the first file is available, accessing the first file using a server local to the client machine; and
creating the configuration file associated with the first file, wherein the configuration file identifies the server local to the client machine.

8. The method of claim 7, wherein the remote machine is separated from the client machine by a firewall.

9. A computer-implemented method of discovering a database server used to access a first file stored on a remote machine from a client machine, the method comprising:
identifying a location of the first file stored on a remote machine;
accessing a second file on the remote machine; and
accessing the first file using a server identified in the second file.

10. The method of claim 9, wherein the remote machine is separated from the client machine by a firewall.

11. A computer-implemented method of discovering a database server used to access a first file stored on a remote machine from a client machine, the method comprising:
identifying a location of the first file stored on a remote machine;
responsive to determining that a configuration file associated with the first file exists, accessing the-first file using a server identified in the configuration file; and
responsive to determining that a configuration file associated with the first file does not exist, determining if a server local to the first file is available;
responsive to determining that the server local to the first file is available, accessing the first file using the server local to the first file; and
creating the configuration file associated with the first file, wherein the configuration file identifies the server local to the first file;
responsive to determining that no server local to the first file is available, accessing the first file using a server local to the client machine; and
creating the configuration file associated with the first file, wherein the configuration file identifies the server local to the client machine.

12. The method of claim 11, wherein the remote machine is separated from the client machine by a firewall.

13. A system for enabling a client machine to access a data file stored on a remote machine, the system comprising:
a network;
a client machine coupled to the network; and
a remote machine coupled to the network, the remote machine storing the data file and a configuration file and executing a server application, the configuration file accessible by the client machine and containing information that enables the client machine to contact the server application, and the server application configured to access the data file and transmit it to the client machine.

14. The system of claim 13, wherein the remote machine is separated from the client machine by a firewall.

15. A system for enabling a second client machine to access a data file stored on a remote machine, the system comprising:
a network;
a first client machine coupled to the network, the first client machine executing a server application;
a second client machine coupled to the network;
a remote machine coupled to the network, the remote machine storing the data file and a configuration file, the configuration file accessible by the second client machine and containing information that enables the second client machine to contact the server application,
wherein the server application is configured to access the data file and transmit it to the second client machine.

16. The system of claim 15, wherein the remote machine is separated from the client machine by a firewall.

17. A computer program product for discovering a database server to access a first file stored on a remote machine from a client machine, the computer program product stored on a computer readable medium, and adapted to perform the operations of:
identifying a location of the first file stored on a remote machine;
responsive to determining that a configuration file associated with the first file does not exist, determining if a server local to the first file is available;
responsive to determining that the server local to the first file is available, accessing the first file using the server local to the first file; and
creating the configuration file associated with the first file, wherein the configuration file identifies the server local to the first file.

18. The computer program product of claim 17, wherein the remote machine is separated from the client machine by a firewall.

19. A computer program product for discovering a database server to access a first file stored on a remote machine from a client machine, the computer program product stored on a computer readable medium, and adapted to perform the operations of:
identifying a location of a first file stored on a remote machine;
responsive to determining that a configuration file associated with the first file does not exist, determining if a server local to the first file is available;
responsive to determining that no server local to the first file is available, accessing the first file using a server local to the client machine; and
creating the configuration file associated with the first file, wherein the configuration file identifies the server local to the client machine.

20. The computer program product of claim 19, wherein the remote machine is separated from the client machine by a firewall.
